(19) United States
(12) Patent Application Publication
(10) Pub. No.: US 2013/0050420 A1
(43) Pub. Date: Feb. 28, 2013

(54) METHOD AND APPARATUS FOR PERFORMING IMAGE PROCESSING ACCORDING TO DISPARITY INFORMATION

(71) Applicants: Ding-Yun Chen, Taipei City (TW); Cheng-Tsai Ho, Taichung City (TW); Chi-Cheng Ju, Hsinchu City (TW)

(72) Inventors: Ding-Yun Chen, Taipei City (TW); Cheng-Tsai Ho, Taichung City (TW); Chi-Cheng Ju, Hsinchu City (TW)

(21) Appl. No.: 13/423,266

(22) Filed: Mar. 18, 2012

Related U.S. Application Data
(60) Provisional application No. 61/526,250, filed on Aug. 22, 2011.

(51) Int. Cl. H04N 13/04

(52) U.S. Cl. 348/43; 348/E13.064

(57) ABSTRACT

An exemplary image processing method includes obtaining disparity information, and generating output image data by performing an image processing operation upon input image data according to the disparity information. An exemplary image processing apparatus includes a disparity information acquisition circuit and an image processing circuit. The disparity information acquisition circuit is arranged for obtaining disparity information. The image processing circuit is coupled to the disparity information acquisition circuit, and arranged for generating output image data by processing input image data according to the disparity information.

### CROSS REFERENCE TO RELATED APPLICATIONS

This application claims the benefit of U.S. provisional application No. 61/526,250, filed on Aug. 22, 2011 and incorporated herein by reference.

### BACKGROUND

The disclosed embodiments of the present invention relate to image processing techniques, and more particularly, to a method for performing image processing according to disparity information and related apparatus thereof.

With the development of display technology, users are pursing stereoscopic and more real image displays rather than high quality images. There are two techniques of present three-dimensional (3D) video display. One is to use a 3D display apparatus which collaborates with glasses (e.g., shutter glasses), while the other is to directly use a 3D display apparatus without any accompanying glasses. No matter which technique is utilized, the main theory of 3D image display is to make the left eye and the right eye see different images, thus the brain will regard the different images seen from two eyes as a 3D image. A conventional 3D display design directly displays the original left-eye images and right-eye images provided from a 3D video source. However, if the original left-eye images and right-eye images can be processed to enhance the 3D visual effect before displayed on the 3D display apparatus, the user may have improved 3D viewing experience.

In general, to view the 3D images, the user is required to have an adequate 3D video playback apparatus such as a 3D television. If the user has a typical two-dimensional (2D) display apparatus such as a 2D television, the user is only capable of having 2D viewing experience even though the video input is provided from a 3D video source. For example, only the left-eye images or only the right-eye images provided by the 3D video source are displayed on the 2D television. A conventional 2D display design directly displays the original left-eye images/right-eye images provided from the 3D video source. Similarly, if the original left-eye images or the original right-eye images provided from the 3D video source can be processed to enhance the 2D visual effect before displayed on the 2D television, the user may have improved 2D viewing experience.

Thus, there is a need for an innovative image processing scheme which can enhance the 2D/3D visual effect by performing image processing upon input images and then generate output images to the 2D/3D display apparatus, thus allowing the user to have improved 2D/3D viewing experience.

### SUMMARY

In accordance with exemplary embodiments of the present invention, a method for performing image processing according to disparity information and related apparatus thereof are proposed to solve the above-mentioned problems.

According to a first aspect of the present invention, an exemplary image processing method is disclosed. The exemplary image processing method includes: obtaining disparity information; and generating output image data by performing an image processing operation upon input image data according to the disparity information.

According to a second aspect of the present invention, an exemplary image processing apparatus is disclosed. The exemplary image processing apparatus includes a disparity information acquisition circuit and an image processing circuit. The disparity information acquisition circuit is arranged for obtaining disparity information. The image processing circuit is coupled to the disparity information acquisition circuit, and arranged for generating output image data by processing input image data according to the disparity information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a generalized image processing apparatus according to an exemplary embodiment of the present invention.

FIG. 2 is a diagram illustrating a first exemplary implementation of a disparity information acquisition circuit shown in FIG. 1.

FIG. 3 is a diagram illustrating a second exemplary implementation of the disparity information acquisition circuit shown in FIG. 1.

FIG. 4 is a diagram illustrating one exemplary generation of the disparity information.

FIG. 5 is a diagram illustrating another exemplary generation of the disparity information.

FIG. 6 is a diagram illustrating a first exemplary implementation of the disparity-based image processing operation performed by the image processing circuit shown in FIG. 1.

FIG. 7 is a diagram illustrating a second exemplary implementation of the disparity-based image processing operation performed by the image processing circuit shown in FIG. 1.

FIG. 8 is a diagram illustrating a third exemplary implementation of the disparity-based image processing operation performed by the image processing circuit shown in FIG. 1.

FIG. 9 is a diagram illustrating a fourth exemplary implementation of the disparity-based image processing operation performed by the image processing circuit shown in FIG. 1.

FIG. 10 is a diagram illustrating a fifth exemplary implementation of the disparity-based image processing operation performed by the image processing circuit shown in FIG. 1.

FIG. 11 is a diagram illustrating a sixth exemplary implementation of the disparity-based image processing operation performed by the image processing circuit shown in FIG. 1.

FIG. 12 is a diagram illustrating a seventh exemplary implementation of the disparity-based image processing operation performed by the image processing circuit shown in FIG. 1.

FIG. 13 is a diagram illustrating an eighth exemplary implementation of the disparity-based image processing operation performed by the image processing circuit shown in FIG. 1.

FIG. 14 is a diagram illustrating a ninth exemplary implementation of the disparity-based image processing operation performed by the image processing circuit shown in FIG. 1.

FIG. 15 is a diagram illustrating a tenth exemplary implementation of the disparity-based image processing operation performed by the image processing circuit shown in FIG. 1.

FIG. 16 is a diagram illustrating an eleventh exemplary implementation of the disparity-based image processing operation performed by the image processing circuit 104 shown in FIG. 1.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The main concept of the present invention is to receive multi-view images (e.g., stereo images including a plurality of image pairs, each having one left-eye image and a right-eye image), and enhance one received image according to other received image(s). Specifically, the present invention proposes performing image processing upon input images by referring to disparity information, thereby generating output images with enhanced image quality. Based on the disparity information, one or more image processing/adjusting schemes are used to adjust pixels in an input image. In this way, the user can have improved viewing experience when the output images are displayed on a display apparatus. Further details of the present invention are described as below.

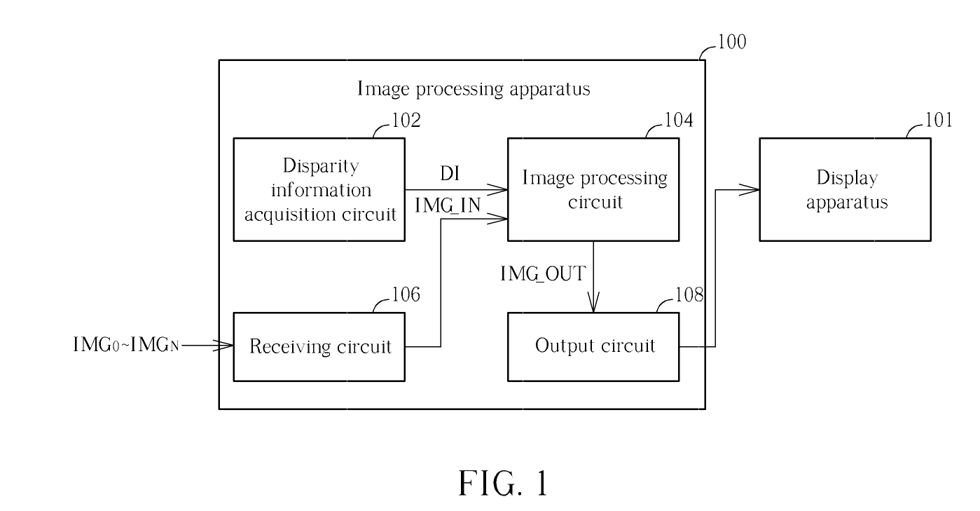

FIG. 1 is a diagram illustrating a generalized image processing apparatus according to an exemplary embodiment of the present invention. The exemplary image processing apparatus 100 includes, but is not limited to, a disparity information acquisition circuit 102, an image processing circuit 104, a receiving circuit 106 and an output circuit 108. The disparity information acquisition circuit 102 is arranged for obtaining disparity information DI. The receiving circuit 106 is arranged for receiving multi-view images IMG₀-IMG_{N}, and provides input image data IMG_IN (e.g., one input image of the received multi-view images) to the image processing circuit 104. The image processing circuit 104 is coupled to the disparity information acquisition circuit 102 and the receiving circuit 106, and arranged for processing the input image data IMG_IN according to the disparity information DI and accordingly generating output image data IMG_OUT (e.g., one or more enhanced output images derived from processing one input image). The output circuit 108 is coupled to the image processing circuit 104, and arranged for transmitting the output image data IMG_OUT to a display apparatus 101 for playback. To put it simply, the disparity information DI is referenced by the image processing circuit 104 to decide how to adjust the input image data IMG_IN for achieving enhanced image quality.

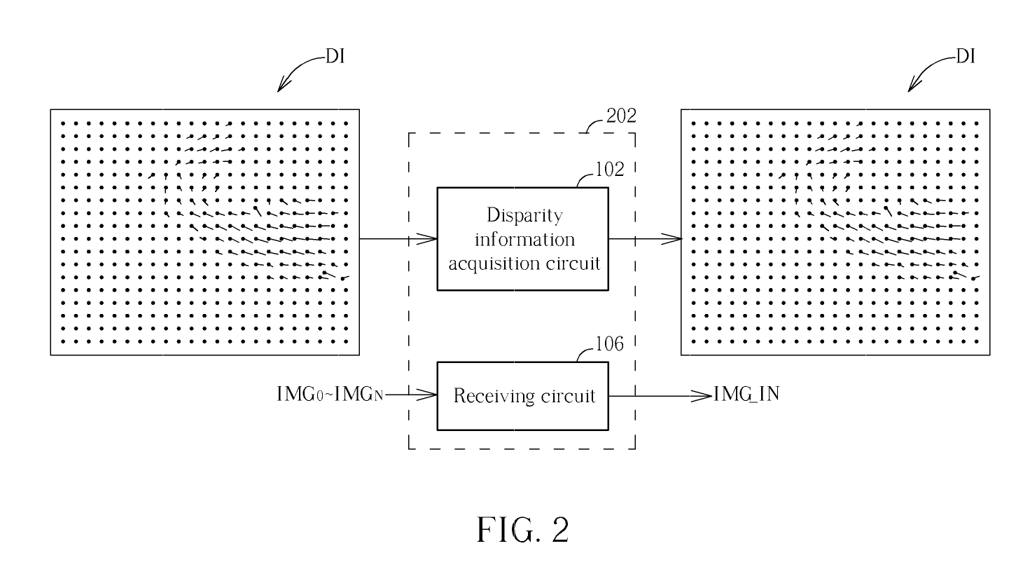

FIG. 2 is a diagram illustrating a first exemplary implementation of the disparity information acquisition circuit 102 shown in FIG. 1. As shown in the figure, the disparity information acquisition circuit 102 is part of a receiving interface 202. Hence, the disparity information acquisition circuit 102 simply receives the disparity information DI provided by an external apparatus (not shown) with disparity computation capability, and provides the received disparity information DI to the image processing circuit 104. By way of example, the disparity information DI may include disparity vectors corresponding to a plurality of pixels, as shown in FIG. 2. However, this is for illustrative purposes only, and is not meant to be a limitation of the present invention. That is, the disparity information DI may be recorded using any format recognized/supported by the image processing circuit 104 Therefore, by referring to the disparity information DI, the image processing circuit 104 can readily know a disparity value of each pixel to be processed.

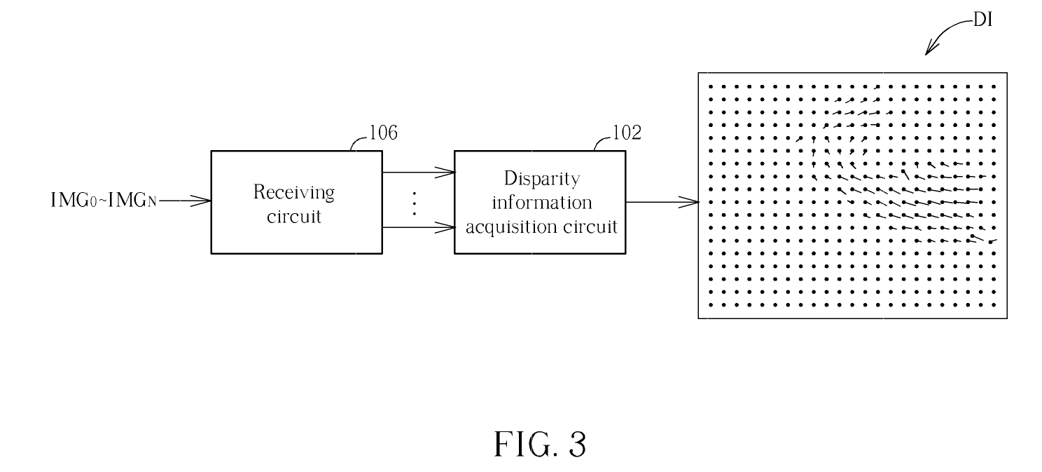

FIG. 3 is a diagram illustrating a second exemplary implementation of the disparity information acquisition circuit 102 shown in FIG. 1. As shown in the figure, the receiving circuit 106 is also coupled to the disparity information acquisition circuit 102. Therefore, the disparity information acquisition circuit 102 derives the disparity information DI from processing images included in the multi-view images IMG₀-IMG_{N} received by the receiving circuit 106. In other words, the disparity information acquisition circuit 102 is equipped with disparity computation capability, and is used to calculate the disparity information DI needed by the image processing circuit 104.

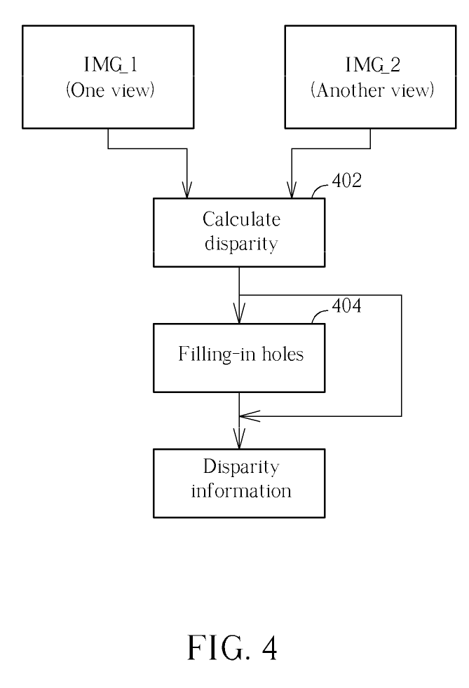

The desired disparity information DI may be calculated from two or more multi-view images. Consider a case where the multi-view images IMG₀-IMG_{N} include images of a left-eye view and a right-eye view. For example, one left-eye image and one right-eye image are captured by different cameras at the same time. An image pair including a left-eye image and a right-eye image may be processed by the disparity information acquisition circuit 102 to obtain the disparity information DI. Please refer to FIG. 4, which is a diagram illustrating one exemplary generation of the disparity information. One of the images IMG_1 and IMG_2 is a left-eye image, and the other of the images IMG_1 and IMG_2 is a right-eye image. Step 402 is executed by the disparity information acquisition circuit 102 to compare pixels of the image IMG_1 with pixels of the image IMG_2, and determine the disparity according to pixel displacement of matched pixels respectively found in the images IMG_1 and IMG_2. It is possible that a pixel in one of the images IMG_1 and IMG_2 has no matched pixel that can be found in the other of the images IMG_1 and IMG_2. The optional step 404 may be executed to determine disparity of such a pixel, for example, by performing interpolation based on disparity values of neighboring pixels. After the step 402 or the steps 402 and 404 are executed, the desired disparity information needed by the following image processing circuit 104 for processing at least one of the images IMG_1 and IMG_2 is obtained by the disparity information acquisition circuit 102.

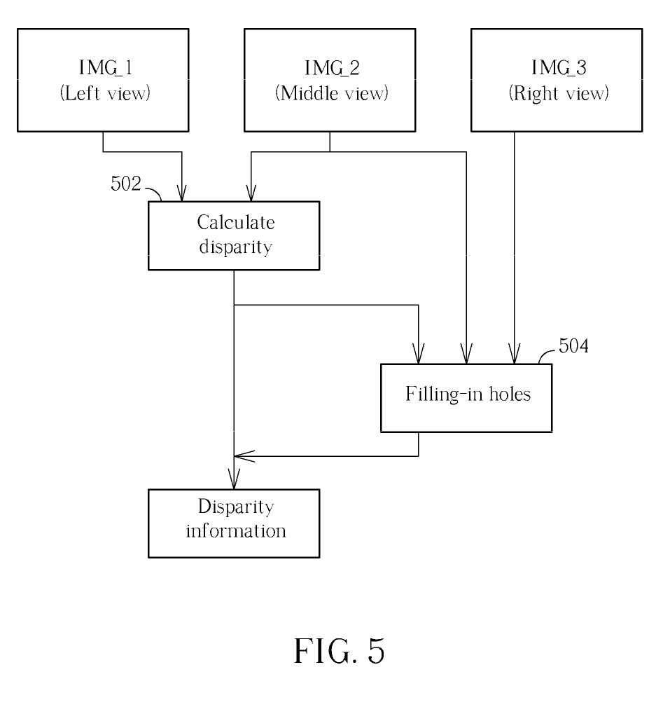

Consider another case where the multi-view images IMG₀-IMG_{N} include images of more than two views. For example, images corresponding different viewing angles are captured by a single camera at different time points. Therefore, more than two images corresponding to different viewing angles may be processed by the disparity information acquisition circuit 102 to obtain the disparity information DI. Please refer to FIG. 5, which is a diagram illustrating another exemplary generation of the disparity information. For clarity and simplicity, only three images IMG_1, IMG_2 and IMG_3 are shown in FIG. 5, where the images IMG_1, IMG_2 and IMG_3 correspond to different viewing angles such as a left view, a middle view, and a right view. In this example, step 502 is executed by the disparity information acquisition circuit 102 to compare pixels of the image IMG_1 with pixels of the image IMG_2, and determine the disparity according to pixel displacement of matched pixels found in the images IMG_1 and IMG_2. As mentioned above, it is possible that a pixel in one of the images IMG_1 and IMG_2 has no matched pixel that can be found in the other of the images IMG_1 and IMG_2. The optional step 504 may be executed to determine disparity of such a pixel, for example, by referring to the disparity information found using the images IMG_2 and IMG_3. After the step 502 or the steps 502 and 504 are executed, the desired disparity information needed by the following image processing circuit 104 for processing at least one of the images IMG_1-IMG_3 is obtained by the disparity information acquisition circuit 102.

In above examples shown in FIG. 4 and FIG. 5, only the spatial information found using images of different views is used to determine the disparity information. Alternatively, temporal information found using different images of the same view may also be involved in determining the disparity information. In an alternative design, multiple multi-view images are used to determine spatial information and temporal information, where the disparity information is determined according to the spatial information and temporal information. The same objective of obtaining the disparity information is achieved.

After receiving the disparity information DI generated from the disparity information acquisition circuit 102, the image processing circuit 104 is operative to generate the output image data IMG_OUT by processing the input image data IMG_IN according to the disparity information DI. Supposing that the display apparatus 101 is a 2D display apparatus and the multi-view images IMG₀-IMG_{N} are derived from a 3D video input, the image processing circuit 104 shown in FIG. 1 is used for processing one of the images IMG_1 and IMG_2 shown in FIG. 4 according to the disparity information DI and accordingly generating one or more 2D output images to the display apparatus 101 for 2D playback. For example, animated GIF images may be derived from processing one of the images IMG_1 and IMG_2 according to the disparity information DI and displayed on the 2D display apparatus, thus presenting a 3D-like image output for the user. Similarly, regarding the exemplary disparity computation case shown in FIG. 5, the image processing circuit 104 may be used for processing one of the images IMG_1 and IMG_2 shown in FIG. 5 according to the disparity information DI and accordingly generating one or more 2D output images to the display apparatus 101 for 2D playback. Compared to the conventional design of directly displaying one of the stereo images/multi-view images on a 2D display apparatus, the image processing apparatus 100 is capable of enhancing the 2D image quality by outputting one or more enhanced images to the display apparatus 101. In the following, several examples of the disparity-based image processing operation performed by the image processing circuit 104 are illustrated.

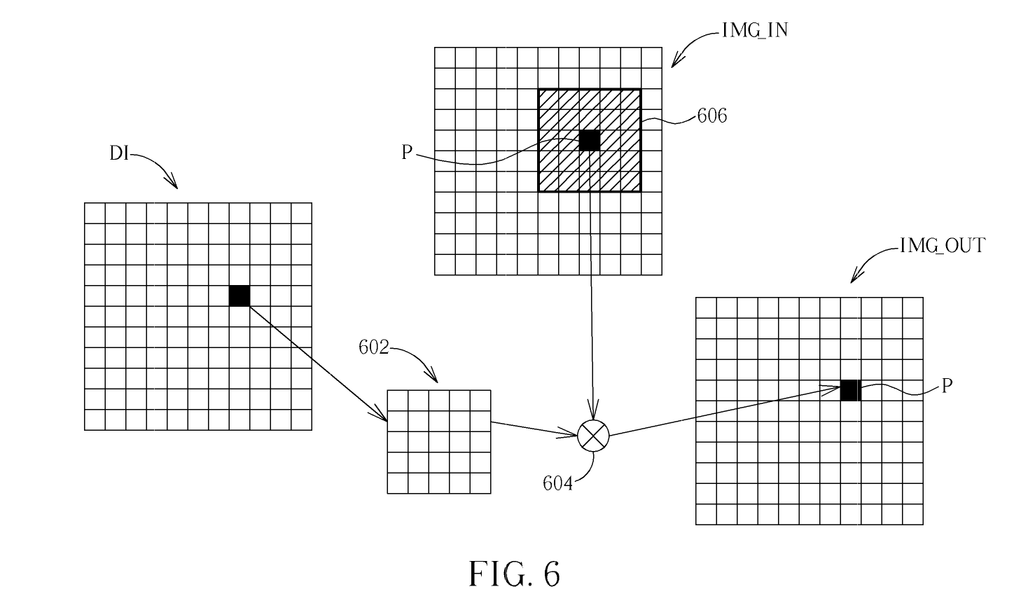

FIG. 6 is a diagram illustrating a first exemplary implementation of the disparity-based image processing operation performed by the image processing circuit 104 shown in FIG. 1. The image processing circuit 104 is arranged to obtain a target kernel filter 602 for each pixel according to the disparity information DI (e.g., a disparity value of the pixel P to be processed), and then apply the target kernel filter 602 to one or more pixels of the input image data IMG_IN via an adjusting unit such as a multiplier 604. In this example, the size of the target kernel filter 602 is 5×5. Therefore, the image processing circuit 104 refers to the disparity information DI (e.g., the disparity value of the pixel P to be processed) to calculate coefficients of the target kernel filter 602. Next, the target kernel filter 602 is applied to pixels within a 5×5 region 606 of the input image data IMG_IN, where the center of the 5×5 region 606 is the pixel P to be processed. A pixel value determined by the target kernel filter 602 would be assigned to the pixel P in the output image data IMG_OUT.

It should be noted that the size of the target kernel filter 602 is not limited to 5×5. In practice, the size of the target kernel filter 602 is adjustable, depending upon actual design consideration/requirement. In other words, the size of the target kernel filter 602 is M×M, where M may be any positive integer. By way of example, but not limitation, the size of the target kernel filter 602 is 3×3 to meet the requirement of one application, and the size of the target kernel filter 602 is 7×7 to meet the requirement of another application.

In one exemplary design, the target kernel filter 602 dynamically calculated by the image processing circuit 104 for each pixel may be a sharpness filter. Hence, the image processing circuit 104 generates a sharper filter output when the display information DI indicates that the pixel P to be processed has a larger disparity value.

In another exemplary design, the target kernel filter 602 dynamically calculated by the image processing circuit 104 for each pixel may be a blur filter. Hence, the image processing circuit 104 generates a more blurred filter output when the display information DI indicates that the pixel P to be processed has a smaller disparity value.

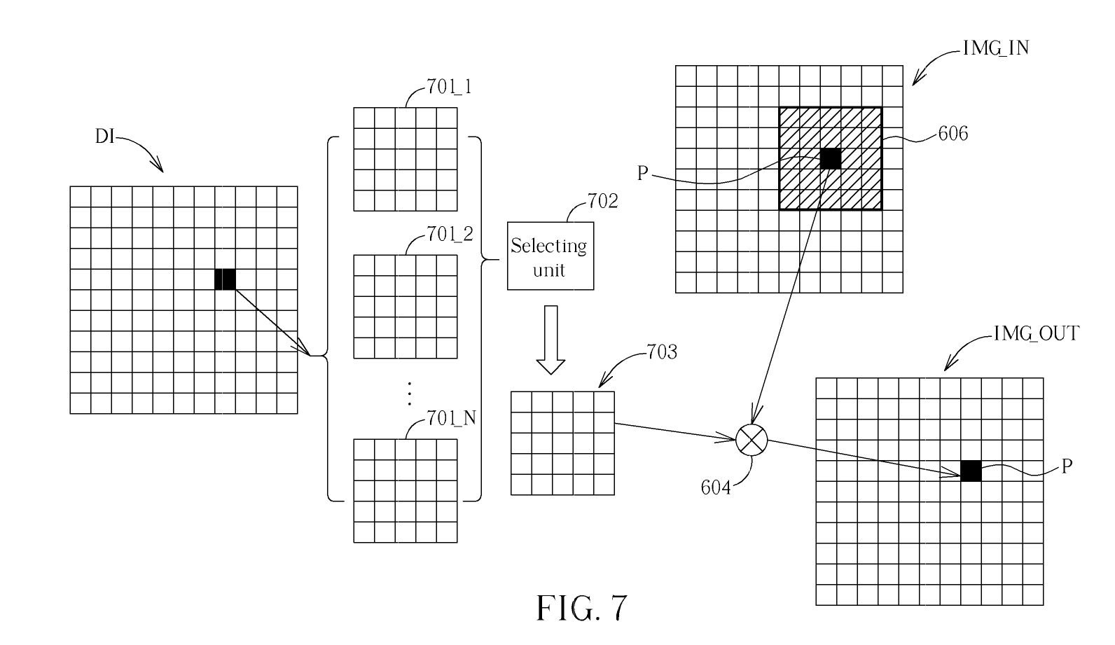

FIG. 7 is a diagram illustrating a second exemplary implementation of the disparity-based image processing operation performed by the image processing circuit 104 shown in FIG. 1. The image processing circuit 104 is arranged to obtain a target kernel filter 703 for each pixel according to the disparity information DI (e.g., a disparity value of the pixel P to be processed), and then apply the target kernel filter 703 to one or more pixels of the input image data IMG_IN via the multiplier 604. The major difference between the exemplary implementations shown in FIG. 6 and FIG. 7 is that the image processing circuit 104 in FIG. 7 is configured to further include a plurality of pre-defined kernel filters 701_1, 701_2 . . . 701_N and a selecting unit 702. The selecting unit 702 is arranged for referring to the disparity information DI (e.g., the disparity value of the pixel P to be processed) to select one of the pre-defined kernel filters 701_1-701_N as the target kernel filter 703. Similarly, as shown in FIG. 7, the size of each of the pre-defined kernel filters 701_1-701_N is 5×5. Therefore, the target kernel filter 702 is applied to pixels within the 5×5 region 606 having the pixel P as its center. Next, a pixel value determined by the target kernel filter 702 would be assigned to the pixel P in the output image data IMG_OUT.

It should be noted that the size of each of the pre-defined kernel filters 701_1-701_N is not limited to 5×5. In practice, the size of the pre-defined kernel filter is adjustable, depending upon actual design consideration/requirement. In other words, the size of each of the pre-defined kernel filters 701_1-701_N is M×M, where M may be any positive integer. By way of example, but not limitation, the size of each of the pre-defined kernel filters 701_1-701_N is 3×3 to meet the requirement of one application, and the size of each of the pre-defined kernel filters 701_1-701_N is 7×7 to meet the requirement of another application.

In one exemplary design, the pre-defined kernel filters 701_1-701_N may be sharpness filters having different sharpness levels. Hence, the image processing circuit 104 generates a sharper filter output when the display information DI indicates that the pixel P to be processed has a larger disparity value.

In another exemplary design, the pre-defined kernel filters 701_1-701_N may be blur filters having different blur levels. Hence, the image processing circuit 104 generates a more blurred filter output when the display information DI indicates that the pixel P to be processed has a smaller disparity value.

In yet another exemplary design, the pre-defined kernel filters 701_1-701_N may include sharpness filters and blur filters, where the sharpness filters have different sharpness levels, and the blur filters have different blur levels. Hence, the disparity value decides which one of the sharpness filters and blur filters would be selected as the target kernel filter 703 for the pixel P to be processed.

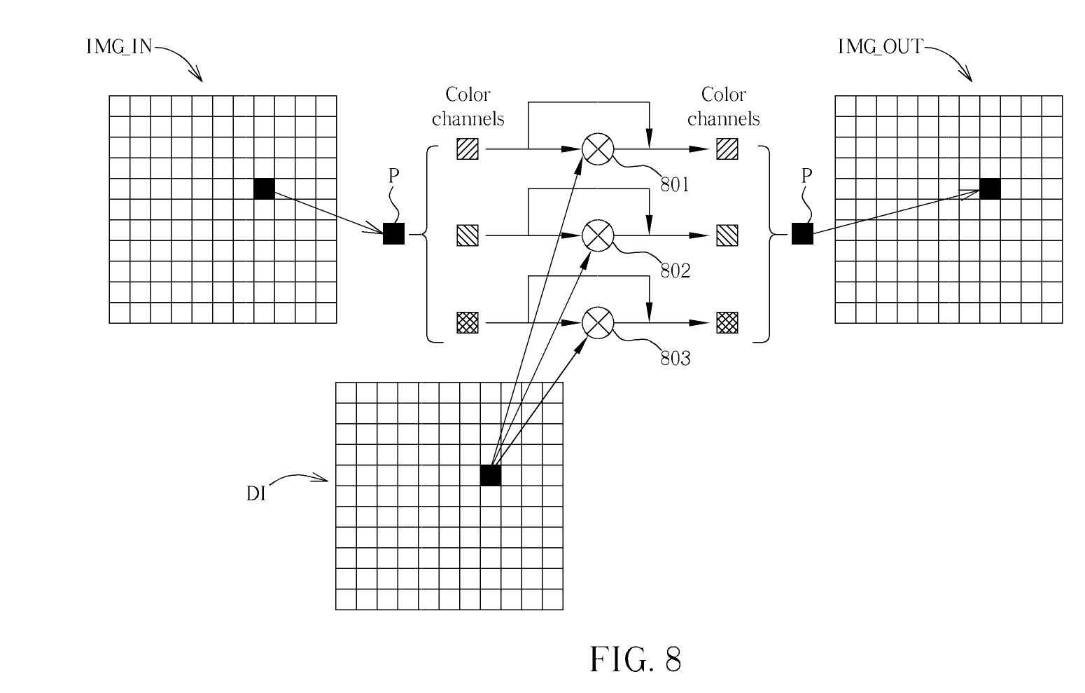

FIG. 8 is a diagram illustrating a third exemplary implementation of the disparity-based image processing operation performed by the image processing circuit 104 shown in FIG. 1. The image processing circuit 104 is arranged to perform color adjustment upon each pixel of the input image data IMG_IN. Specifically, each pixel includes a plurality of color component values corresponding to a plurality of different color channels (e.g., R, G and B channels), respectively. In this example, the image processing circuit 104 may include a plurality of adjusting units 801, 802, 803 disposed at different color channels, and refers to the disparity information DI (e.g., the disparity value of the pixel P to be processed) to selectively adjust at least one of the color component values. Hence, the color component values determined by the adjusting units 801-803 would be assigned to the pixel P in the output image data IMG_OUT.

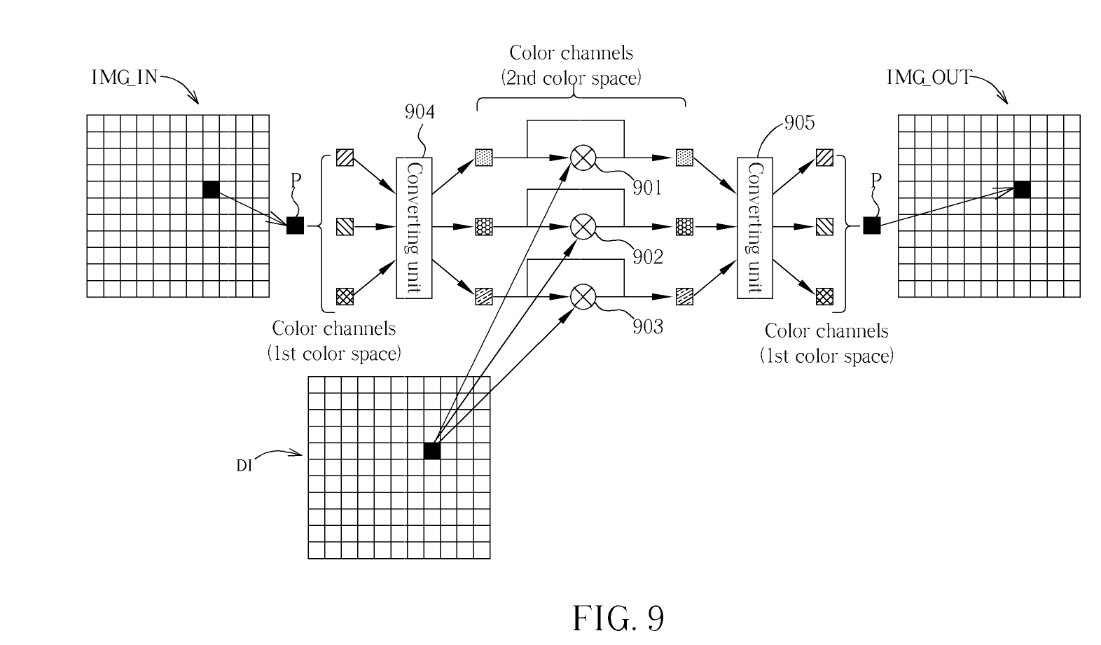

FIG. 9 is a diagram illustrating a fourth exemplary implementation of the disparity-based image processing operation performed by the image processing circuit 104 shown in FIG. 1. The image processing circuit 104 is arranged to perform saturation adjustment and/or brightness adjustment upon each pixel of the input image data IMG_IN. Specifically, each pixel of the input image data IMG_IN includes a plurality of color component values corresponding to a plurality of different color channels (e.g., R, G and B channels) in a first color space. In this example, the image processing circuit 104 may include a plurality of adjusting units 901, 902, 903 and a plurality of converting units 904 and 905. The converting 904 is arranged for converting color component values corresponding to different color channels (e.g., R, G and B channels) in the first color space into color component values corresponding to a plurality of different color channels (e.g., Y, U and V channels) in a second color space. The adjusting units 901-903 are disposed at different color channels in the second color space, and refer to the disparity information DI (e.g., the disparity value of the pixel P to be processed) to selectively adjust at least one of the color component values. Next, the converting unit 905 converts color component values generated from the adjusting units 901-903 into color component values in the first color space. Hence, the color component values determined by the adjusting units 901-903 and then converted by the converting unit 905 would be assigned to the pixel Pin the output image data IMG_OUT.

In one exemplary design, the image processing circuit 104 may be configured to adjust saturation of the pixel P. Therefore, the image processing circuit 104 increases the saturation of the pixel P by performing the saturation adjustment in the second color space when the disparity information DI indicates that the pixel P to be processed has a larger disparity value, and/or the image processing circuit 104 decreases the saturation of the pixel P by performing the saturation adjustment in the second color space when the disparity information DI indicates that the pixel P to be processed has a smaller disparity value.

In another exemplary design, the image processing circuit 104 may be configured to adjust brightness/intensity of the pixel P. Therefore, the image processing circuit 104 increases the brightness of the pixel P by performing the brightness/intensity adjustment in the second color space when the disparity information DI indicates that the pixel P to be processed has a larger disparity value, and/or the image processing circuit 104 decreases the brightness of the pixel P by performing the brightness/intensity adjustment in the second color space when the disparity information DI indicates that the pixel P to be processed has a smaller disparity value.

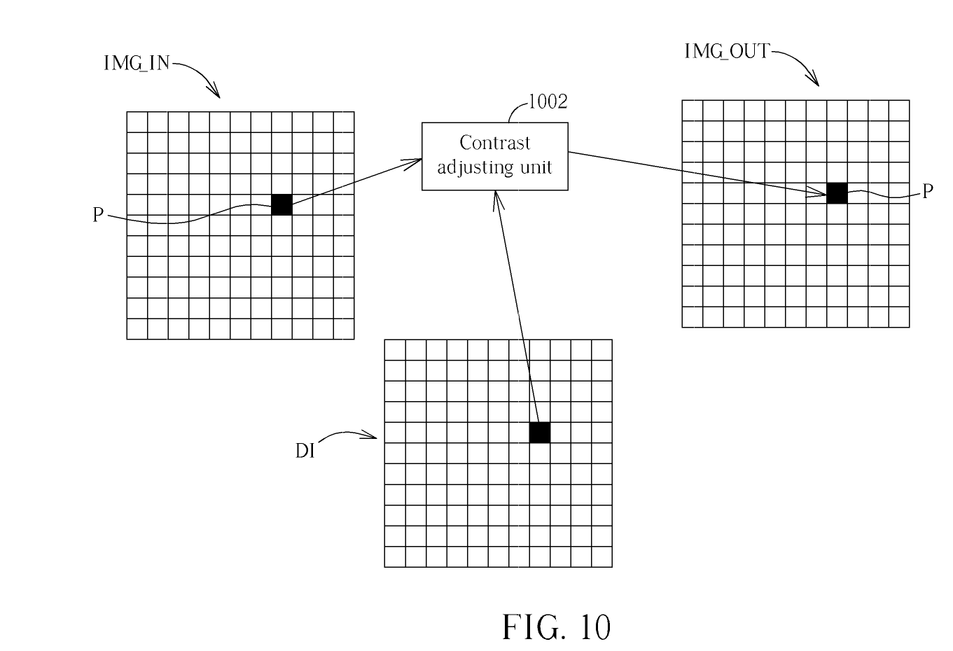

FIG. 10 is a diagram illustrating a fifth exemplary implementation of the disparity-based image processing operation performed by the image processing circuit 104 shown in FIG. 1. The image processing circuit 104 includes a contract adjusting unit 1002 arranged for performing contrast adjustment upon each pixel in the input image data IMG_IN according to the disparity information DI. More specifically, the contract adjusting unit 1002 increases the contrast of the pixel P when the disparity information DI indicates that the pixel P to be processed has a larger disparity value, and/or the contract adjusting unit 1002 decreases the contrast of the pixel P when the disparity information DI indicates that the pixel P to be processed has a smaller disparity value.

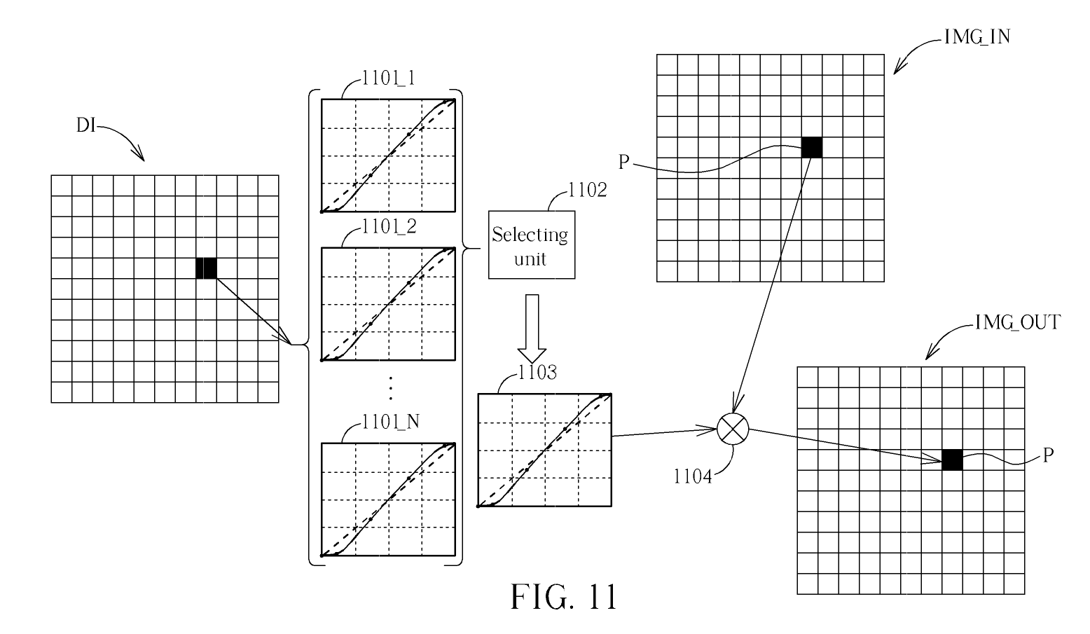

FIG. 11 is a diagram illustrating a sixth exemplary implementation of the disparity-based image processing operation performed by the image processing circuit 104 shown in FIG. 1. The image processing circuit 104 is arranged to apply gamma curve adjustment to each pixel in the input image data IMG_IN according to the disparity information DI. In this example, the image processing circuit 104 obtains a target gamma curve 1103 for the pixel P according to the disparity information DI, and uses an adjusting unit (e.g., a multiplier 1104) to apply the target gamma curve 1103 to the pixel P. More specifically, the image processing circuit 104 further includes a plurality of pre-defined gamma curves 1101_1, 1101_2 . . . 1101_N and a selecting unit 1102. The selecting unit 1102 refers to the disparity information DI (e.g., the disparity value of the pixel P to be processed) to select one of the pre-defined gamma curves 1101_1-1101_N as the target gamma curve 1103. Next, a pixel value determined by the target gamma curve 1103 would be assigned to the pixel P in the output image data IMG_OUT.

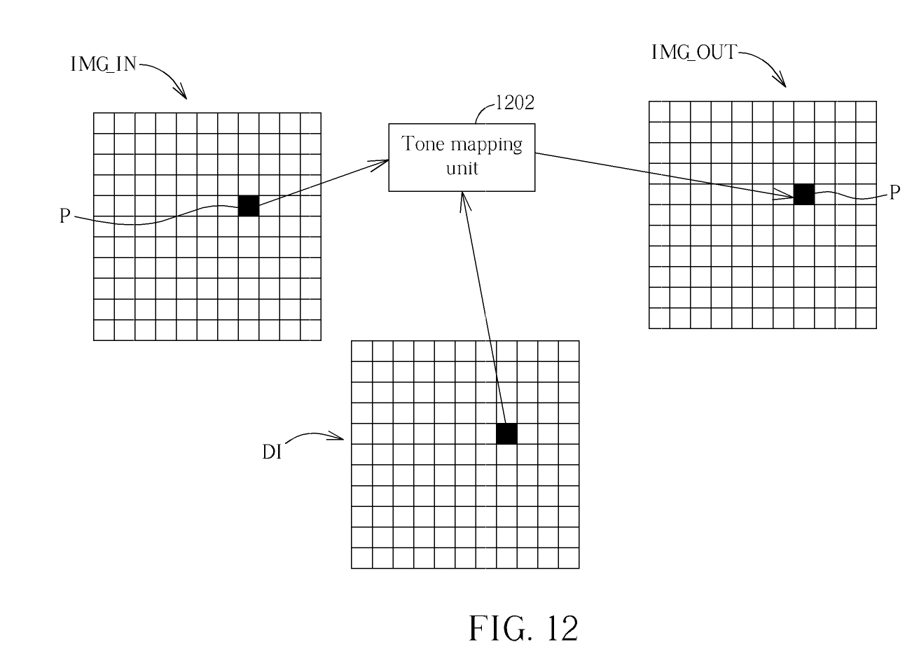

FIG. 12 is a diagram illustrating a seventh exemplary implementation of the disparity-based image processing operation performed by the image processing circuit 104 shown in FIG. 1. The image processing circuit 104 includes a tone mapping unit 1202 arranged for performing dynamic range adjustment according to the disparity information DI. More specifically, the tone mapping unit 1202 increases the dynamic range of the pixel P when the disparity information DI indicates that the pixel P to be processed has a larger disparity value, and/or the tone mapping unit 1202 decreases the dynamic range of the pixel P when the disparity information DI indicates that the pixel P to be processed has a smaller disparity value. For example, when a higher dynamic range is employed by the tone mapping unit 1202, pixel values in a specific pixel value range would be mapped to pixel values in a comparatively large pixel value range; and when a lower dynamic range is employed by the tone mapping unit 1202, pixel values in the specific pixel value range would be mapped to pixel values in a comparatively small pixel value range.

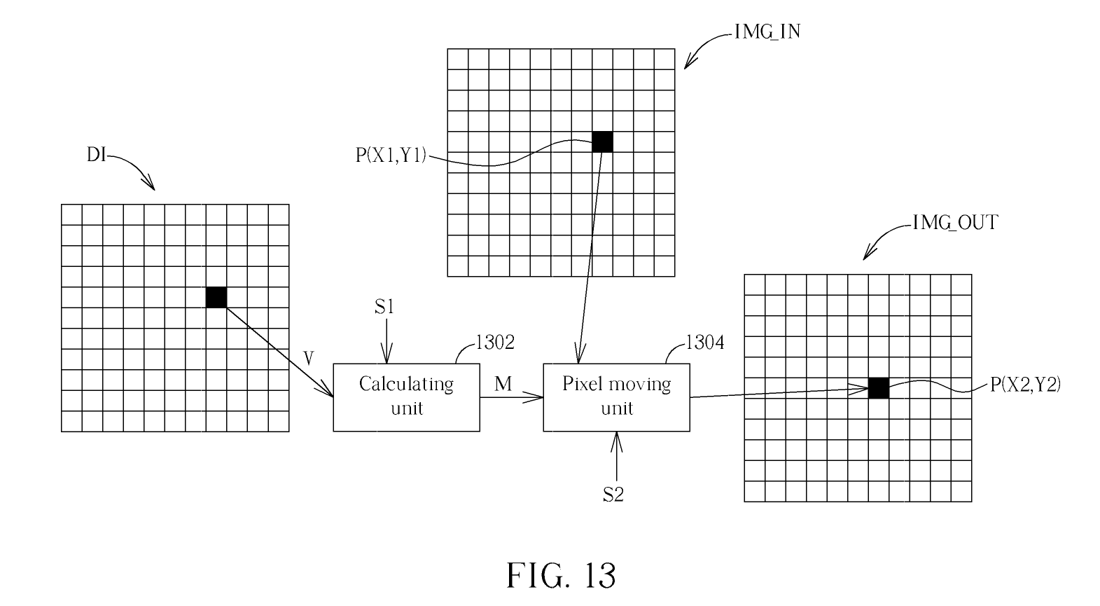

FIG. 13 is a diagram illustrating an eighth exemplary implementation of the disparity-based image processing operation performed by the image processing circuit 104 shown in FIG. 1. The image processing circuit 104 refers to the disparity information DI to move each pixel in the input image data IMG_IN. In this example, the image processing circuit 104 includes a calculating unit 1302 and a pixel moving unit 1304. The calculating unit 1302 is arranged for determining move magnitude of the pixel P to be processed according to the disparity information DI (e.g., the disparity value of the pixel P) and a first parameter S1 that defines a movement range. For example, the movement range is delimited by the minimum move magnitude M_MIN and the maximum move magnitude M_MAX, where the minimum move magnitude M_MIN corresponds to a smallest disparity value V_MIN (M=M_MIN if V=V_MIN), and the maximum move magnitude M_MAX corresponds to a largest disparity value V_MAX (M=M_MAX if V=V_MAX). Therefore, when the disparity value of the pixel P located at the position (X1,Y1) is V (V_MIN<V<V_MAX), the move magnitude M of the pixel P may be determined using the following equation.

$$\frac{M - M\_MIN}{V - V\_MIN} = \frac{M\_MAX - M\_MIN}{V\_MAX - V\_MIN} \qquad ( 1 )$$

Hence, the calculating unit 1302 would make the move magnitude M larger when the disparity information D1 indicates that the pixel P has a larger disparity value V, and/or the calculating unit 1302 would make the move magnitude M smaller when the disparity information D1 indicates that the pixel P has a smaller disparity value V.

In an alternative design, the minimum move magnitude M_MIN corresponds to the largest disparity value V_MAX (M=M_MIN if V=V_MAX), and the maximum move magnitude M_MAX corresponds to the smallest disparity value V_MIN (M=M_MAX if V=V_MIN). Therefore, when the disparity value of the pixel P located at the position (X1,Y1) is V (V_MIN<V<V_MAX), the move magnitude M of the pixel P may be determined using the following equation.

$$\frac{M\_MAX - M}{V - V\_MIN} = \frac{M\_MAX - M\_MIN}{V\_MAX - V\_MIN} \qquad ( 2 )$$

Hence, the calculating unit 1302 would make the move magnitude M smaller when the disparity information D1 indicates that the pixel P has a larger disparity value V, and/or the calculating unit 1302 would make the move magnitude M larger when the disparity information D1 indicates that the pixel P has a smaller disparity value V.

The pixel moving unit 1304 is coupled to the calculating unit 1302, and arranged for moving the pixel P according to the move magnitude M and a second parameter S2 that defines a move direction. As shown in FIG. 13, the pixel P defined in the output image data IMG_OUT is located at the position (X2,Y2) which is different from the original position (X1,Y1) defined in the input image data IMG_IN. To ensure that each pixel in the output image is properly assigned a pixel value, one practical implementation of the pixel moving unit 1304 may sequentially determine pixel values of pixels in the output image in a specific order (e.g., a raster scan order) by performing search/interpolation upon pixel values in the input image according to move magnitude information and move direction information. By way of example, when determining the pixel value of the pixel located at the position (X2,Y2) defined in the output image data IMG_OUT, the pixel moving unit 1304 refers to the move magnitude M and the move direction defined by the second parameter S2 to know that the pixel value of the pixel P located at the position (X1,Y1) should be used to set the pixel value of the pixel located at the position (X2,Y2). The same objective of moving the pixel P located at the position (X1,Y1) in the input image to the position (X2,Y2) in the output image is achieved. Considering a case where the pixel moving unit 1304 fails to directly find a pixel value in the input image to set a pixel value of a specific pixel in the output image, the pixel moving unit 1304 may determine the pixel value of the specific pixel in the output image by interpolation or other computation/determination algorithm. In this way, each pixel in the output image is guaranteed to have a pixel value though one or more pixels in the input image may be moved to new positions in the output image.

It should be noted that the first parameter S1 and the second parameter S2 may be set by a user interactive input or a pre-defined parameter setting. That is, the movement range and the move direction may be pre-defined or user-controlled.

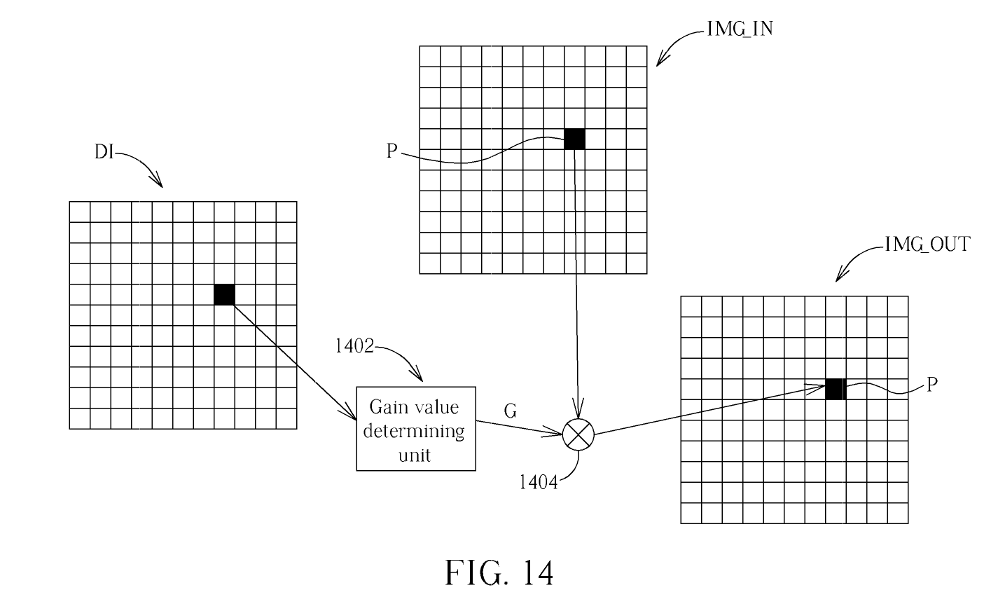

FIG. 14 is a diagram illustrating a ninth exemplary implementation of the disparity-based image processing operation performed by the image processing circuit 104 shown in FIG. 1. The image processing circuit 104 applies gain adjustment to each pixel in the input image data IMG_IN according to the disparity information DI. In this example, the image processing circuit 104 includes a gain value determining unit 1402 and an adjusting unit 1404. The gain value determining unit 1402 is arranged for referring to the disparity information DI (e.g., the disparity value of the pixel P to be processed) to determine a gain value G for the pixel P. The adjusting unit 1404 is coupled to the gain value determining unit 1402, and arranged for applying the gain value G to the pixel P for adjusting a pixel value of the pixel P. For example, the adjusting unit 1404 is implemented by a multiplier, and a result of multiplying the pixel value of the pixel P with the gain value G is assigned to the pixel P in the output image data IMG_OUT.

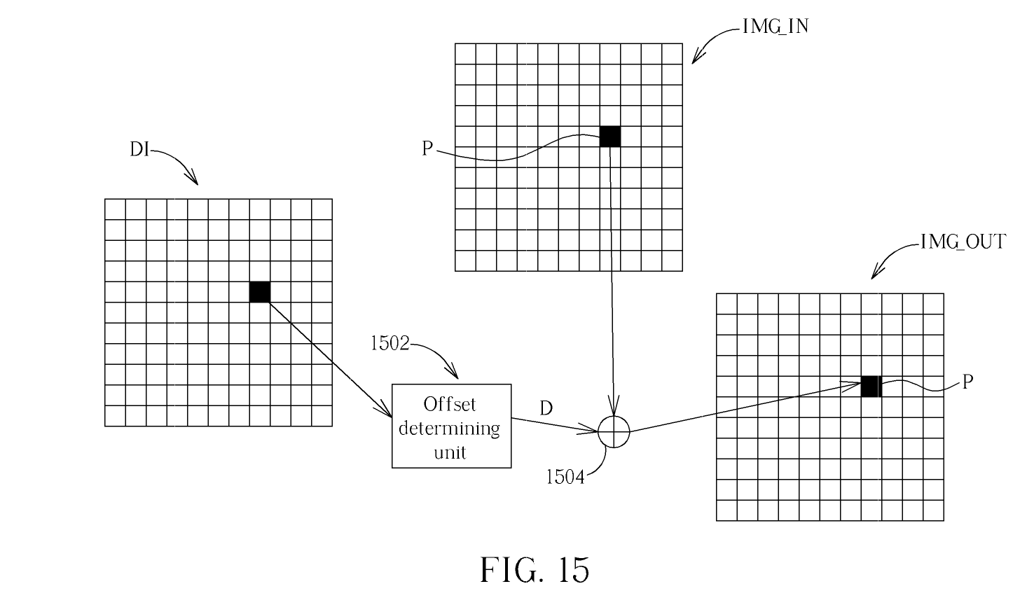

FIG. 15 is a diagram illustrating a tenth exemplary implementation of the disparity-based image processing operation performed by the image processing circuit 104 shown in FIG. 1. The image processing circuit 104 applies offset adjustment to each pixel in the input image data IMG_IN according to the disparity information DI. In this example, the image processing circuit 104 includes an offset value determining unit 1502 and an adjusting unit 1504. The offset value determining unit 1502 is arranged for referring to the disparity information DI (e.g., the disparity value of the pixel P to be processed) to determine an offset value D for the pixel P. The adjusting unit 1504 is coupled to the offset value determining unit 1502, and arranged for applying the offset value D to the pixel P for adjusting a pixel value of the pixel P. For example, the adjusting unit 1504 is implemented by an adder, and a result of summing up the pixel value of the pixel P and the offset value D is assigned to the pixel P in the output image data IMG_OUT.

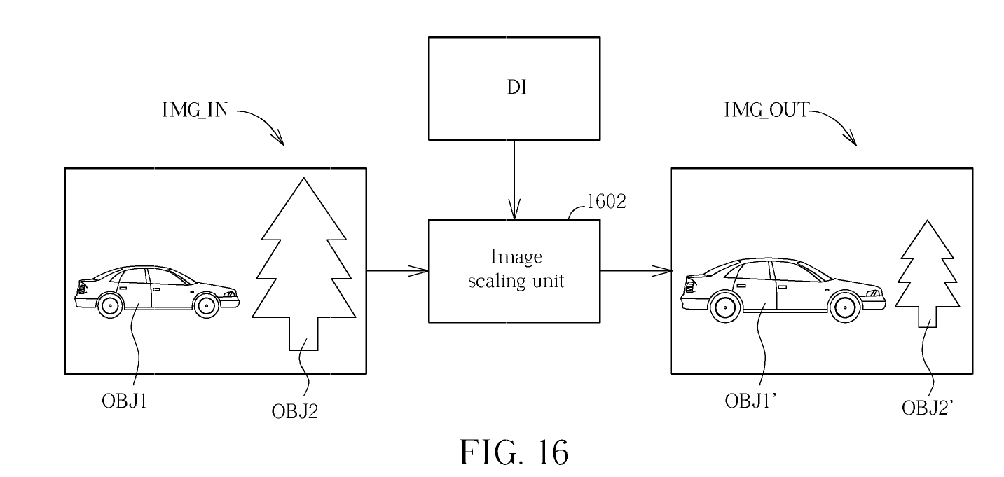

FIG. 16 is a diagram illustrating an eleventh exemplary implementation of the disparity-based image processing operation performed by the image processing circuit 104 shown in FIG. 1. The image processing circuit 104 includes an image object scaling unit 1602 arranged to perform scaling upon image object(s) in the input image data IMG_IN according to the disparity information DI. Therefore, based on the disparity information DI, the image size of an image object in an output image corresponding to the output image data IMG_OUT may be smaller or larger than the image size of the same image object in an input image corresponding to the input image data IMG_IN. By way of example, but not limitation, the input image may include two image objects OBJ1 and OBJ2. When the disparity information DI indicates that the image object OBJ1 has larger disparity and the image object OBJ2 has smaller disparity, the image object scaling unit 1602 therefore enlarges the image object OBJ1 and shrinks the image object OBJ2, thus making the image object OBJ1′ in the output image have an increased image size and the image object OBJ2′ in the output image have a decreased image size. To put it simply, as the size/resolution of the input image corresponding to the input image data IMG_IN is the same as that of the output image corresponding to the output image data IMG_OUT, the image objects in the input image would be emphasized or de-emphasized in the output image by the image object scaling unit 1602 based on respective disparity conditions derived from the disparity information DI.

Please note that the aforementioned exemplary implementations of the disparity-based image processing operation performed by the image processing circuit 104 shown in FIG. 1 is not required to be pixel-based. Alternatively, the aforementioned exemplary implementations of the disparity-based image processing operation performed by the image processing circuit 104 shown in FIG. 1 may be properly modified to be block-based. For example, an average of disparity values of pixels in a block may be referenced for determining the adjustment made to pixel values of all pixels in the block. Briefly summarized, the spirit of the present invention is obeyed as long as an input image is adjusted according to the disparity information.

Consider another case where the display apparatus 101 is a 3D display apparatus and the multi-view images IMG₀-IMG_{N} are derived from a 3D video input. The disparity information DI may be referenced by any of the aforementioned exemplary implementations of the disparity-based image processing operation performed by the image processing circuit 104 to adjust one or both of the left-eye image and the right-eye image for 3D display quality enhancement. This also falls within the scope of the present invention.

The image processing circuit 104 may employ one of the aforementioned exemplary disparity-based image processing operations for processing an input image having the input image data IMG_IN. However, this is for illustrative purposes only, and is not meant to be a limitation of the present invention. Based on the design consideration/requirement, the image processing circuit 104 may employ a combination of multiple image processing operations selected from the aforementioned exemplary disparity-based image processing operations for processing an input image having the input image data IMG_IN. To put it simply, any image processing design using one or more of the aforementioned exemplary disparity-based image processing operations falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
obtaining disparity information; and
generating output image data by performing an image processing operation upon input image data according to the disparity information.

2. The image processing method of claim 1, further comprising:
receiving a plurality of multi-view images;
wherein the step of obtaining the disparity information comprises:
deriving the disparity information from processing the multi-view images.

3. The image processing method of claim 1, further comprising:
receiving a plurality of multi-view images, wherein one of the multi-view images acts as the input image data.

4. The image processing method of claim 3, wherein the multi-view images are derived from a three-dimensional (3D) video input, and includes a pair of a left-eye image and a right-eye image, and the image processing method further comprises:
outputting the output image data to a two-dimensional (2D) display apparatus.

5. The image processing method of claim 1, wherein the step of performing the image processing operation comprises:
obtaining a target kernel filter according to the disparity information; and
applying the target kernel filter to one or more pixels of the input image data.

6. The image processing method of claim 5, wherein the step of obtaining the target kernel filter comprises:
referring to the disparity information to calculate coefficients of the target kernel filter.

7. The image processing method of claim 5, wherein the step of obtaining the target kernel filter comprises:
referring to the disparity information to select one of a plurality of pre-defined kernel filters as the target kernel filter.

8. The image processing method of claim 5, wherein the target kernel filter is a sharpness filter.

9. The image processing method of claim 8, wherein the image processing operation generates a sharper filter output when the disparity information has a larger disparity value.

10. The image processing method of claim 5, wherein the target kernel filter is a blur filter.

11. The image processing method of claim 10, wherein the image processing operation generates a more blurred filter output when the disparity information has a smaller disparity value.

12. The image processing method of claim 1, wherein the step of performing the image processing operation comprises:
performing color adjustment according to the disparity information.

13. The image processing method of claim 12, wherein the color adjustment is configured to adjust saturation of one or more pixels of the input image data.

14. The image processing method of claim 13, wherein the image processing operation increases the saturation when the disparity information has a larger disparity value, or the image processing operation decreases the saturation when the disparity information has a smaller disparity value.

15. The image processing method of claim 1, wherein the step of performing the image processing operation comprises:
adjusting brightness of one or more pixels of the input image data according to the disparity information.

16. The image processing method of claim 15, wherein the image processing operation increases the brightness when the disparity information has a larger disparity value, or the image processing operation decreases the brightness when the disparity information has a smaller disparity value.

17. The image processing method of claim 1, wherein the step of performing the image processing operation comprises:
adjusting contrast of one or more pixels of the input image data according to the disparity information.

18. The image processing method of claim 17, wherein the image processing operation increases the contrast when the disparity information has a larger disparity value, or the image processing operation decreases the contrast when the disparity information has a smaller disparity value.

19. The image processing method of claim 1, wherein the step of performing the image processing operation comprises:
obtaining a target gamma curve according to the disparity information; and
applying the target gamma curve to one or more pixels of the input image data.

20. The image processing method of claim 1, wherein the step of performing the image processing operation comprises:
obtaining a target tone mapping according to the disparity information; and
applying the target tone mapping to one or more pixels of the input image data.

21. The image processing method of claim 20, wherein the image processing operation increases a dynamic range when the disparity information has a larger disparity value, or the image processing operation decreases the dynamic range when the disparity information indicates a smaller disparity value.

22. The image processing method of claim 1, wherein the step of performing the image processing operation comprises:
moving one or more pixels of the input image data according to the disparity information.

23. The image processing method of claim 22, wherein the step of moving one or more pixels of the input image data comprises:
determining move magnitude according to the disparity information and a first parameter that defines a movement range; and
moving one or more pixels of the input image data according to the move magnitude and a second parameter that defines a move direction.

24. The image processing method of claim 23, wherein the step of moving one or more pixels of the input image data further comprises:
setting the first parameter and the second parameter by receiving a user interactive input or referring to a pre-defined parameter setting.

25. The image processing method of claim 23, wherein the image processing operation makes the move magnitude larger when the disparity information has a larger disparity value, or the image processing operation makes the move magnitude smaller when the disparity information has a smaller disparity value.

26. The image processing method of claim 23, wherein the image processing operation makes the move magnitude smaller when the disparity information has a larger disparity value, or the image processing operation makes the move magnitude larger when the disparity information has a smaller disparity value.

27. The image processing method of claim 1, wherein the step of performing the image processing operation comprises:
determining a gain value according to the disparity information; and
applying the gain value to one or more pixels of the input image data.

28. The image processing method of claim 1, wherein the step of performing the image processing operation comprises:
determining an offset value according to the disparity information; and
applying the offset value to one or more pixels of the input image data.

29. The image processing method of claim 1, wherein the step of performing the image processing operation comprises:
performing scaling upon at least one image object in the input image data according to the disparity information.

30. An image processing apparatus, comprising:
a disparity information acquisition circuit, arranged for obtaining disparity information; and
an image processing circuit, coupled to the disparity information acquisition circuit and arranged for generating output image data by processing input image data according to the disparity information.

31. The image processing apparatus of claim 30, further comprising:
a receiving circuit, coupled to the disparity information acquisition circuit and arranged for receiving a plurality of multi-view images;
wherein the disparity information acquisition circuit derives the disparity information from processing the multi-view images.

32. The image processing apparatus of claim 30, further comprising:
a receiving circuit, coupled to the image processing circuit and arranged for receiving a plurality of multi-view images;
wherein one of the multi-view images acts as the input image data.

33. The image processing apparatus of claim 32, wherein the multi-view images are derived from a three-dimensional (3D) video input, and includes a pair of a left-eye image and a right-eye image, and the image processing apparatus further comprises:
an output circuit, coupled to the image processing circuit and arranged for outputting the output image data to a two-dimensional (2D) display apparatus.

34. The image processing apparatus of claim 30, wherein the image processing circuit has a target kernel filter obtained according to the disparity information, and applies the target kernel filter to one or more pixels of the input image data.

35. The image processing apparatus of claim 34, wherein the image processing circuit refers to the disparity information to calculate coefficients of the target kernel filter.

36. The image processing apparatus of claim 34, wherein the image processing circuit comprises:
a plurality of pre-defined kernel filters; and
a selecting unit, arranged for referring to the disparity information to select one of the pre-defined kernel filters as the target kernel filter.

37. The image processing apparatus of claim 34, wherein the target kernel filter is a sharpness filter.

38. The image processing apparatus of claim 37, wherein the image processing circuit generates a sharper filter output when the disparity information has a larger disparity value.

39. The image processing apparatus of claim 34, wherein the target kernel filter is a blur filter.

40. The image processing apparatus of claim 39, wherein the image processing circuit generates a more blurred filter output when the disparity information has a smaller disparity value.

41. The image processing apparatus of claim 30, wherein the image processing circuit performs color adjustment according to the disparity information.

42. The image processing apparatus of claim 41, wherein the color adjustment is configured to adjust saturation of one or more pixels of the input image data.

43. The image processing apparatus of claim 42, wherein the image processing circuit increases the saturation when the disparity information has a larger disparity value, or the image processing circuit decreases the saturation when the disparity information has a smaller disparity value.

44. The image processing apparatus of claim 30, wherein the image processing circuit adjusts brightness of one or more pixels of the input image data according to the disparity information.

45. The image processing apparatus of claim 44, wherein the image processing circuit increases the brightness when the disparity information has a larger disparity value, or the image processing circuit decreases the brightness when the disparity information has a smaller disparity value.

46. The image processing apparatus of claim 30, wherein the image processing circuit is arranged to adjust contrast of one or more pixels of the input image data according to the disparity information.

47. The image processing apparatus of claim 46, wherein the image processing circuit increases the contrast when the disparity information has a larger disparity value, or the image processing circuit decreases the contrast when the disparity information has a smaller disparity value.

48. The image processing apparatus of claim 30, wherein the image processing circuit obtains a target gamma curve according to the disparity information, and applies the target gamma curve to one or more pixels of the input image data.

49. The image processing apparatus of claim 30, wherein the image processing circuit obtains a target tone mapping according to the disparity information, and applies the target tone mapping to one or more pixels of the input image data.

50. The image processing apparatus of claim 49, wherein the image processing circuit increases a dynamic range when the disparity information has a larger disparity value, or the image processing circuit decreases the dynamic range when the disparity information indicates a smaller disparity value.

51. The image processing apparatus of claim 30, wherein the image processing circuit moves one or more pixels of the input image data according to the disparity information.

52. The image processing apparatus of claim 51, wherein the image processing circuit comprises:
a calculating unit, arranged for determining move magnitude according to the disparity information and a first parameter that defines a movement range; and
a pixel moving unit, coupled to the calculating unit and arranged for moving one or more pixels of the input image data according to the move magnitude and a second parameter that defines a move direction.

53. The image processing apparatus of claim 52, wherein the first parameter and the second parameter are set by a user interactive input or a pre-defined parameter setting.

54. The image processing apparatus of claim 52, wherein the calculating unit makes the move magnitude larger when the disparity information has a larger disparity value, or the calculating unit makes the move magnitude smaller when the disparity information has a smaller disparity value.

55. The image processing apparatus of claim 52, wherein the calculating unit makes the move magnitude smaller when the disparity information has a larger disparity value, or the calculating unit makes the move magnitude larger when the disparity information has a smaller disparity value.

56. The image processing apparatus of claim 30, wherein the image processing circuit comprises:
a gain value determining unit, arranged for determining a gain value according to the disparity information; and
an adjusting unit, coupled to the gain value determining unit and arranged for applying the gain value to one or more pixels of the input image data.

57. The image processing apparatus of claim 30, wherein the image processing circuit comprises:
an offset value determining unit, arranged for determining an offset value according to the disparity information; and
an adjusting unit, coupled to the offset value determining unit and arranged for applying the offset value to one or more pixels of the input image data.

58. The image processing apparatus of claim 30, wherein the image processing circuit performs scaling upon at least one image object in the input image data according to the disparity information.
